(19) United States
(12) Patent Application Publication
(10) Pub. No.: US 2020/0249936 A1
(43) Pub. Date: Aug. 6, 2020

(54) METHOD AND SYSTEM FOR A PLATFORM FOR API BASED USER SUPPLIED ALGORITHM DEPLOYMENT

(71) Applicant: James Ronald Barfield, JR., Atlanta, GA (US)

(72) Inventor: James Ronald Barfield, JR., Atlanta, GA (US)

(73) Assignee: James Ronald Barfield, JR., Atlanta, GA (US)

(21) Appl. No.: 16/776,662

(22) Filed: Jan. 30, 2020

Related U.S. Application Data
(60) Provisional application No. 62/800,654, filed on Feb. 4, 2019.

(51) Int. Cl. G06F 8/656; G06F 8/41; H04L 29/08

(52) U.S. Cl. CPC G06F 8/656; H04L 67/34; G06F 8/433

(57) ABSTRACT

A system for deploying user supplied algorithms that inserts the user supplied algorithms and creates application program interfaces within client or server devices. The user supplied algorithm is analyzed and software dependencies are determined along with computation that influences the systems decision to deploy the algorithm for inference on the device or in a cloud server device. Server type selection is determined based on analyst of the user supplied algorithm by the system and the user supplied algorithm is deployed in a selectable efficient manner. Using the user supplied algorithm, a sample a sample set of software is generated from analyst and deployment through an application program interface. The sample set of software can be used by the user to demonstrate the algorithm function in technologies like TOT devices, Smartphone apps or websites.

### CROSS-REFERENCE TO RELATED APPLICATIONS

This application claims benefit of provisional application Ser. No. 60/800,654, filed Feb. 4, 2019 by the present inventor.

### FIELD

Aspects disclosed herein relate to deploying, scaling, and managing user created algorithms as application program interfaces used for devices or web data.

### BACKGROUND

Aspects disclosed herein related to a deployment system for user supplied algorithm inference particular to performing the inference on the device and in the cloud and creating applications encompassing a user supplied algorithm.

A user supplied algorithm may be a method, system to processes some type of data type by means of heuristically implemented, machine learning, or deep learning method. Typically, user supplied algorithms can be deployed as an application program interface (API) or in a device such as a smartphone, IOT device, or computer that is a manual process. The manual process may include writing code to make an API via writing code, configuring security and servers, and manually specifying software dependencies. Software dependencies installation for a user supplied is a manual process in which the user manually specifies a way to install software dependencies. Deciding to deploy on a device or in a cloud is a manual process.

### SUMMARY

The embodiment specifies a system to scale manage and deploy user supplied algorithms in a cloud infrastructure or on a device. The system describes methods to manage when to perform user supplied algorithm inference on a device or in the cloud, a method for a user to provide a user supplied algorithm and the system to automatically or pseudo-automatically deploy a scalable user supplied algorithm as an API (application program interface) both on devices or in a cloud system, and automatic or pseudo-automatic generation of demonstration applications for the user supplied algorithm provided. In other aspects of the embodiment, a method for automation of user supplied algorithm dependency generation is discussed, and generation and platform selection type for user supplied algorithm deployment as an API is explained.

### BRIEF DESCRIPTION OF THE DRAWINGS

FIG. 1 describes an overview of how Devices interact with Device APIs and Cloud APIs contained in different types of user supplied algorithm deployment platforms.

FIG. 2 describes a system overview to train, deploy, and manage user supplied algorithm functions in a user supplied algorithm deployment platform.

FIG. 3 describes a method for a user supplied algorithm deployment by a user.

FIG. 4 describes a method that determines performance of a user supplied algorithm inference on a device, device with algorithm with acceleration, or in a cloud server.

FIG. 5 describes a method for a user to deploy a user supplied algorithm as a device API and a Cloud API.

FIG. 6 describes elements of a method for a of a user interface for deployment of a user supplied algorithm system.

FIG. 7 describes a method to determine when to do user supplied algorithm inference on devices versus through a server-based API.

FIG. 8 describes a method for generating demonstration applications for a user supplied algorithm.

FIG. 9 describes a method of testing and choosing a platform type for a user supplied algorithm.

FIG. 10 describes a method for automatic or pseudo-automatic generation of an API from a provided user supplied algorithm and automatic dependency import of dependent code.

### DETAILED DESCRIPTION

As a preliminary matter, it will be readily understood by those persons skilled in the art that the present invention is susceptible of broad utility and application. Many methods, aspects, embodiments, and adaptations of the present invention other than those herein described, as well as many variations, modifications, and equivalent arrangements, will be apparent from or reasonably suggested by the substance or scope of the described aspects.

Accordingly, while the present invention has been described herein in detail in relation to preferred embodiments and aspects, it is to be understood that this disclosure is only illustrative and exemplary of the present invention and is made merely for the purposes of providing a full and enabling disclosure of the invention. The following disclosure is not intended nor is to be construed to limit the present invention or otherwise exclude any such other embodiments, adaptations, variations, modifications and equivalent arrangements, the present invention being limited only by the claims appended hereto and the equivalents thereof being limited only by the claims appended hereto and the equivalents thereof.

This invention describes a platform for hosting user supplied algorithms or models and does not seek to patent aspects of algorithms themselves but is a system to allow a user to deploy, scale and manage user supplied algorithms automatically or pseudo-automatically. User supplied algorithms may refer to an algorithm or method set defined by a user supplying the algorithm or method set for the deployment, scaling and management of user supplied algorithms automatically or pseudo-automatically. Within context of the platform for hosting at the forefront within are defined by choosing the best platform for a user supplied algorithm to be hosted with the methods described herein and showing the tradeoffs to the user of a particular platform to host the user supplied algorithm using a Device API and a Cloud API; a method deciding when to perform inference on the device and when and why the system should perform inference in the cloud; and a method to automatically create apps, websites, demonstration products, and embedded system demonstration applications from a user supplied algorithm deployed in the system.

A Device herein is described as a smartphone, IOT device such as a camera, an embedded chipset, or a network connected device with sensors. In some instances, a device may refer to a set of software that operates as a client such as a website that may be a server executing a set of code or instructions. Sensors may be described as image sensors, LIDAR sensors, radar sensors, light sensors, inertial measurement sensors, barometric sensors, audio sensors, or any sensor connected to a device that produces data that an algorithm function or method may be applied. Web services may be defined as a service offered by an electronic device such as a Server to another electronic device that may be referred to as a Device, communicating with each other, with a network, or the world wide web. Application program interface (API) is a set of routines, protocols, and tools for building software applications that specifies how software components interact. Herein the APIs may be in the form of a Cloud API or a Device API that are defined by a tool for accessing or using a user supplied algorithm on a device or in the cloud. A Device API may refer to the routines, protocols, and tools for a software application that specify how to utilize a user supplied algorithm functions on the Device; it may refer to the routines, protocols, and tools for a software application that specify how software components interact for connecting to a Cloud API and accessing or using a user supplied algorithm or function and determine an output. Herein a Cloud API may refer to a set of routines, protocols, and tools for building software applications that specifies components for a user supplied algorithm or function that produces an output. The APIs may use a web service that may be defined by REST framework, a stream of information, or a series of machine instructions. Algorithm is a process or set of rules to be followed in calculations or other problem-solving operations, especially by a computer, but herein is defined by a user that may apply the algorithm to sensor information. The embodiment is a system and platform for users to host user supplied algorithms in a device or in a cloud that a user defined. A user supplied algorithm may be an algorithm or set of instructions that a user wishes to perform on a slice of data. Algorithms could be deep learning, machine learning, heuristic based, a hash set of instructions, or self-learned through an artificial intelligence approach. Algorithms could also be a set of code or model in a python, C++, Java or other programming language that perform a function or method on an input data to produce a result. Often a model which is a set of weights that may describe an algorithm function that often may be oriented to matrix mathematics may be defined. Herein a user created model or user specified algorithm may describe an algorithm model created by a user for a particular use case to operate on data also defined by a user. A user may refer to a software developer or a person or machine wishing to use an algorithm or create an algorithm. Algorithm platform type may refer to the platform in which a user supplied algorithm is running within, such as an embedded platform, distributed cloud platform, serverless cloud platform, cloud distributed GPU (graphics processing unit) platform, cloud distributed platform with algorithm acceleration hardware, or a server platform. Web servers may be used for deploy inference algorithm platforms or hosting the algorithms. Kafka is a real-time data pipeline for streaming apps or information. Algorithm weights may refer to the mathematical definition of the model associated with a machine learning algorithm in which an architecture of the algorithm design is recorded and a weight corresponding to a weight of a feature contained within the models themselves or a strength of a synaptic connection of neural network in the instance of a neural network. Algorithm inference often means a conclusion reached based on evidence and reasoning by a method. For example, an algorithm could be designed to classify objects in an image and performing an inference is taking in an image and outputting a list of objects and locations in the image. Inference would be the act of running the function or algorithm to detect objects on the image. Prediction may refer to forecasting or uses statistics to predict outcomes, or it may refer to predictive modeling in a broad sense in which the probability of an outcome is given a set amount of input data in a user supplied algorithm. The system herein focuses on describing a way for APIs to automatically be generated to easily allow for deployments and scaling related to algorithmic inference. Automatic code generation may refer to a machine generated code, an application, or application container that may have a method to generate source code through a mechanism-based approach typically defined by a software application. API Traffic terminology may refer to network traffic, counting the number of API messages, or the number of times an algorithm has been performed and may be performed both on a Cloud API and a Device API. Certificate used herein is referring to a code signing certificate or a digital certificate. Blockchain is a distributed, decentralized, public ledger approach to securing a transaction and can be used to secure APIs. Algorithm training may refer to supervised learning that is a task of learning a function that maps an input to an output based on example input-output pairs. Latency may refer to the execution time of a user supplied algorithm or the time in which data is sent and a return of the user supplied algorithm function is defined. A software dependency, referred herein as dependency, is a term to referring to when a piece of software relies on another one set of software of compiled code. Software Container, referred herein as a Container, is a standard unit of software that packages up code and code dependencies into one computing environment that shares a computer operating system that may not require an operating system to run as a software application.

Algorithms are defined as a set of rules to be followed in calculations or a set of problem-solving operations defined within a computer. Commonly, algorithms are used to enhance products such as mobile apps in smartphones, IOT devices (e.g., network connected video devices, network connected door locks, tracking devices, network-connected light switches, network-connected plugs, network-connected kitchen appliances, network connected light bulbs, network connected smoke detectors, voice enabled hardware assistance, and network-connected thermostats); embedded devices (e.g., connected vehicles, smart infrastructure, Smart home devices, GPS enabled devices, self-driving vehicles, home security systems, robots, and automated teller machines); embedded modules and embedded AI acceleration microchips (e.g., a microprocessor that serves the function of performing a machine learning or deep learning algorithm by optimizing the silicon chip to load algorithm model weights and perform the mathematical operation based on the algorithm model often across many processor or graphics processing unit cores); or websites. Examples of user supplied algorithms to improve products may be using a convolutional neural network object detection algorithm based on images as an input to detect particular objects within an image (e.g., vehicles with an image); using images to detect with a convolutional neural network algorithm anomalies in microprocessor manufacturing based on images; predicting reduction in geographic based inventory based on a convolutional neural network algorithm using the amount of inventory and weather data; suggesting friends in a social network based on interactions and geographic image color. Other examples include the following: corrections using deep learning algorithms; image style transfer from artworks using general adversarial Networks; map object identifications in images using deep learning algorithms; classification of plants in images; translation of language in text using deep learning natural language processing; tumor detection in images of body scans; pneumonia automatic diagnosis in x-ray scans; and file base security monitoring.

This system enables user supplied algorithms such as the ones used in the examples to be applied to products like those listed in the examples. Machine learning algorithms and deep learning algorithms, depending on the model size of the weights corresponding to the deep learning for machine learning architecture, may require machine learning hardware acceleration. Products like the ones listed may have dedicated chips or hardware to enable fast inference of the deep learning or machine learning models; and likewise, cloud based inference may require machine learning hardware acceleration in which a user supplied algorithm may be accessible through on application programming interface.

The embodiment defines automated ways to deploy user supplied algorithms in a variety of cloud-based approaches to host user supplied algorithm software defined by the user: scale the user supplied algorithms so that a dynamic number of users may use a cloud-based API; change the algorithm architectures so that the algorithm may be run in the device if the device is able to run the user supplied algorithm from a computational perspective; apply security between APIs and devices; manage new deployments of user supplied algorithms defined by users; test changes to the user supplied algorithms for particular data types defined automatically; and generate mobile apps, software code, and website code to demonstrate the deployed user supplied algorithm's use. Other approaches include the following: testing and installing software dependencies for the user supplied algorithm automatically, creating containers that define the algorithm and software dependencies as an isolated software environment that can be run on a shared algorithm platform, determining on the device client-side to perform inference with an algorithm on the device or via an API in the cloud, and automatically updating both the algorithm model in the device serving as a client and the model in the cloud algorithm platform. Algorithm acceleration hardware in cloud servers could be a software interface to GPUs to use the many processor cores of the GPUs that perform fast matrix multiplication to which algorithms can be translated. Further, algorithm acceleration could come in the form of multicore chips to optimize the number of trillions of operations per second that may come in the form of an application-specific integrated circuit, GPU, or other type of chip that may be optimized for smartphones or embedded devices.

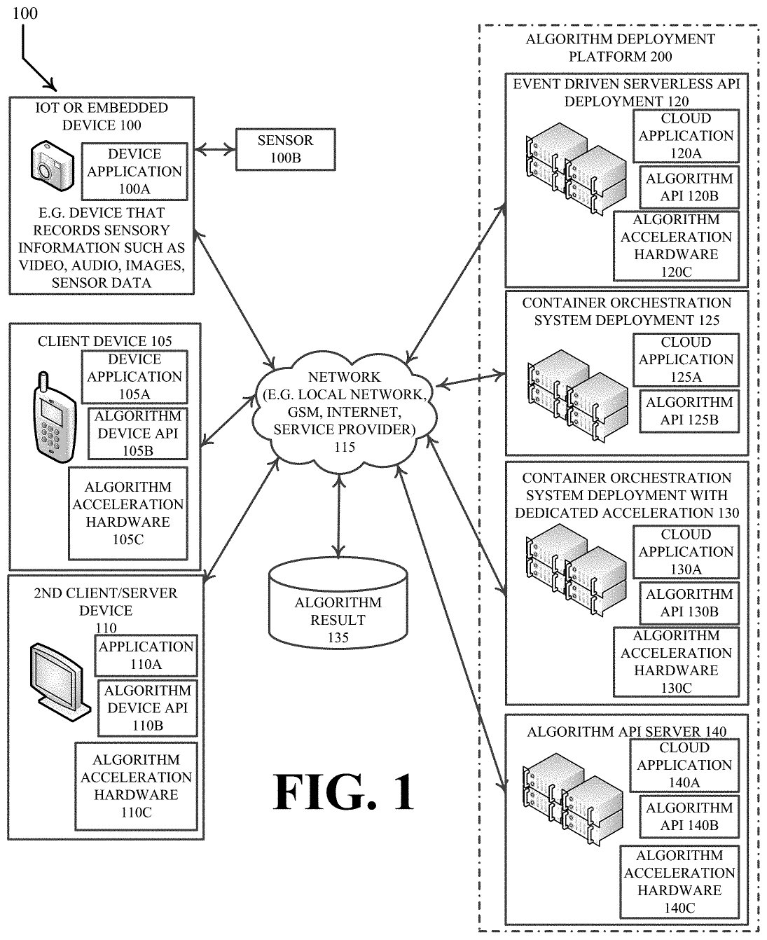

FIG. 1 defines method 100, an overview of how products enabled by client devices, websites, IOT or embedded devices, or client and server devices interact with a cloud-based algorithm deployment platform method 200. There are a variety of approaches to running an algorithm, depending on the application and user supplied algorithm need. One such approach, given an example of object detection operating on an image from a camera, may be to run an algorithm for object detection on the image in the device within a device application (as indicated in client device 105 as 105A) in which the client device may have algorithm acceleration hardware (as indicated by 105C), accessible through a software application algorithm device API (as indicated in 105B). The object detection inference using the object detection algorithm would be fully performed on the client device 105. This approach listed works if the client device as the appropriate algorithm acceleration hardware but would not be an optimal solution if faster acceleration hardware is needed or a lower inference time is needed for the user supplied algorithm. Another approach to host the user supplied algorithm in a server accessible through a network and an API is to access the algorithm (as indicated by the connections from 105 to network 115) to a server (as indicated by 140). This approach listed could allow for better algorithm acceleration hardware (as indicated in 140C) to support the computational requirements of performing the user supplied algorithm function but may experience latency from the network that would not be an optimal solution, depending on server geographic locations and network speed at the time of inference along with scalability of APIs to respond to requests. An application running in a cloud server (as indicated by 140A) provides an interface, typically using an API that provides access to the user supplied algorithm that is accelerated with algorithm acceleration hardware 140C. A solution to the potential non-optimal solutions is to measure the latency between 105 and 140 and to rely on 105 for an algorithm inference if the device is capable of performing the inference based on computation ability and algorithm acceleration hardware. An addition may be to have a secondary client device perform an inference if the latency is low between 105 and the second device (as indicated by 110, as indicated by 110C) that may also include an application 110A and an algorithm device API 110B to perform or provide access to the user supplied algorithm.

The method described herein uses an algorithm development platform 200 to take an algorithm, test the algorithm, and install the necessary dependencies for the user defined software based algorithm or instruction set that can be then deployed as an API to interface with Device applications and algorithm acceleration hardware, either a client device or a cloud orchestration system. Furthermore, a method is used to measure if the client device can perform the algorithm inference. If not, it would rely on the cloud container orchestration system deployment to perform the inference, as indicated by the IOT or embedded device 100 that interacts with sensors 100B to consume an API (e.g., 105B, 120B, 125B, 130B, or 140B) to perform a cloud-based inference with a user supplied algorithm.

The algorithm results may not necessarily be displayed on client devices 100, 105, and 110 but may be shared with a website user interface or placed into a database (as indicated by 135). The determination for the client device to perform the algorithm inference may be based on one or many of the following factors: the device has the required computation ability to do so, it has the ability to perform the inference in a speed less than an API network based inference would take, there is a local client/server device that has a greater ability to perform the algorithm API based inference, model changes in the client device version of the algorithm model has less than desirable accuracies, the client device or API has other operations occurring so that performing the operation in the device would slow the device below a certain threshold, the client device does not have battery life above a specified threshold, the client device does not have the required hardware for algorithm acceleration, or the client device is currently updating the user supplied algorithm in the algorithm acceleration hardware. Regarding different approaches to the deployment platform of the user supplied algorithm to hosting Cloud API's 200 (as indicated by blocks 120, 125, 130, and 135) are different approaches to hosting algorithms and APIs in the cloud. The ways of hosting each have different benefits; and one of the constructs of the embodiment described herein is determining when to use and how to use, and reporting to the user the benefits of using one way of hosting an algorithm over another. Starting with block 120 that indicates an event driven serverless API deployment, algorithms can be deployed as containerized API applications. Serverless runtimes are known to function as service runtimes and are often billed as a pay per code execution, and they operate to load software and dependencies often as a containerized version when the function for the software is called. This type of platform is called a function as a service, and the architecture is typically scalable for smaller software, algorithm models, and dependency packages less than a size like 500 MB.

The fundamentals of a serverless architecture is to have a database of containerized software packaged with their dependencies, and the function of requesting an action to be performed will cold start a software application container that can perform an algorithm operation. The platform may be based in a traditional big data platform such as Apache Storm, or it may run on a platform such as Kubernetes. The Major differentiation between 120 and 125, 130, and 140 is that a function as a service architecture can have longer startup times due to having to load the application from a cold start (e.g., starting application by creating a new container instance, starting the function host process), or having to warm start (e.g., reusing a container from a previous event) in which the application may take time. Block 120 contains 120A that indicates a representation of a containerized application that performs the algorithm function, 120B represents an API function that is generated to provide access to the algorithm function, and 120C may indicate an algorithm hardware acceleration device that operates to increase the inference or speed of the algorithm function. Block 125 contains 125A that indicates a cloud application container that hosts the user supplied algorithm function and 125B that serves as an API layer to provide access to the user's function. Block 125 is a scalable platform that runs container nodes to provide access to the algorithm containers. The platform in 125 may be a container orchestration system that may have multiple nodes of the same containers and may scale the nodes up or down, depending on scaling requirements, and a control layer to determine when scaling should occur with a common API to stream serve to the different nodes. Block 125 may not have a cold start and may be always available but operate at a higher cost associated with the platform and multiple servers to scale up and down computing and memory needs of servers. An even higher monetary or computational cost platform may be 130 that is the same as 125 but with an added algorithm acceleration hardware as indicated by 130C with the nodes across multiple servers. Within the container orchestration system, 125, 125A and 125B are used to provide the cloud application and algorithm access through an API within the orchestration much like the elements that occur in 130 but without the added algorithm acceleration hardware.

User supplied algorithm acceleration hardware is more expensive in cost to the user but may provide faster inference that can be calculated by interfacing the algorithm to the algorithm acceleration hardware and performing the algorithm function and measuring the time required along with memory required for the model. The model for payment for 120 may be based on amount of memory allocated to the container and the execution time of the algorithm function, whereas the pricing for 125, 130, and 140 may be a fixed cost to leave the container always running to avoid a cold start and may provide the ability to include larger algorithm models. When a user submits an algorithm code set and a model, dependencies are created for a container. The container is then analyzed for computation and need for algorithm hardware acceleration. The user is supplied an analysis on the different platforms, including cost to deploy the algorithm in the different platforms and the inference or latency of the algorithm in each of the platforms. One such approach to calculating computation is to run a test of the inference time to completion on the user supplied algorithm in different algorithm acceleration hardware types and in different client device algorithm acceleration types. The resulting measurements of the inference could be latency, amount of memory, the CPU utilization during inference, GPU or algorithm acceleration hardware utilization during the inference, current draw during the inference, total estimated time for the inference including network latency time and memory the algorithm model requires. All these values recorded could be compared to thresholds that provide a determination of where to perform an inference in the different subsystems 100, 105, 110, 120, 125, 130, 135. All these systems are constrained by different inference latency, scalability, power, and resource constraints. A preselection of these constraints dictates the decision to set thresholds motioned to determine where to do the inference. Further, a model such as a convolutional neural network may be trained based on a data set to provide the decision of what subsystems to use to perform the inference.

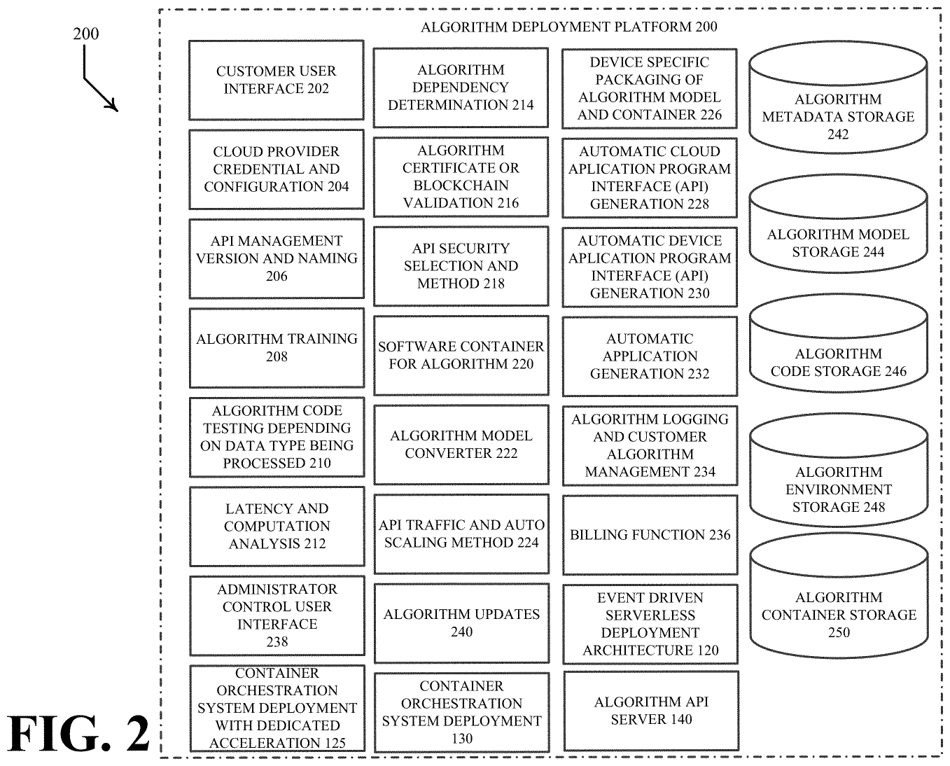

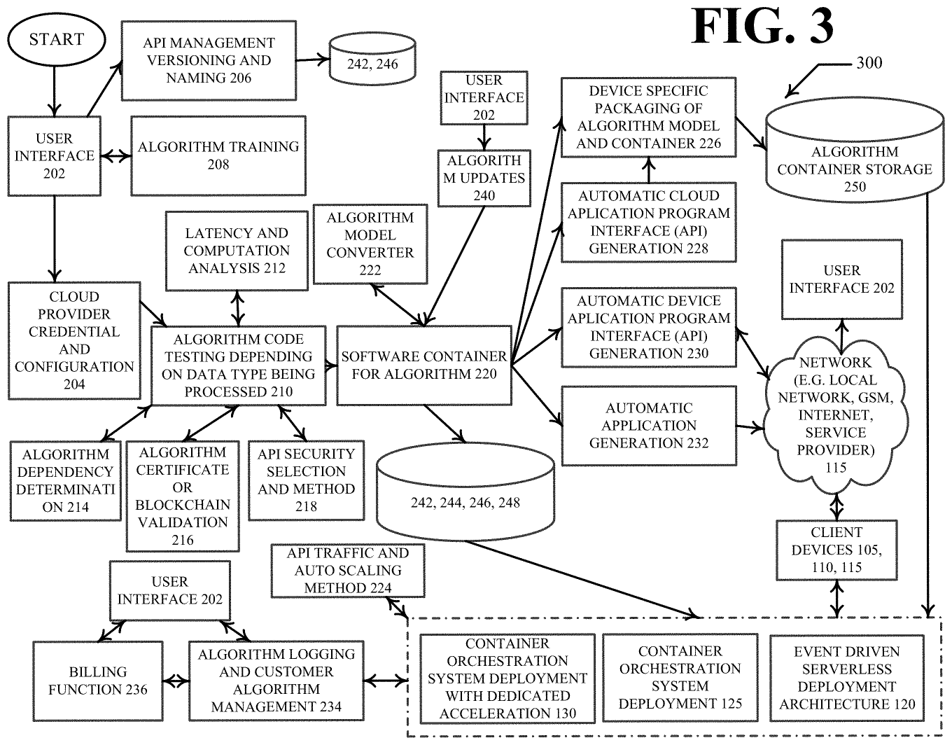

The method 200 of FIG. 2 starts at the user interface block 202 where a user may input code, input models, input instructions, select algorithms, provide naming conventions for application programming interfaces encompassing a user supplied algorithm, provide security settings for application programming interfaces, specify deep learning hardware acceleration, and specify an algorithm training environment or framework. A user may also train different architectures of algorithms such as binary regression tree, recurrent neural networks, General Adversarial Networks, LSTMs, neural networks, or other types of algorithms known as artificial intelligence, deep learning or machine learning. Furthermore, user interface 202 may be used to update algorithms with newer versions, interact with billing features within the algorithmic deployment platform 200, monitor algorithm performance metrics, and deploy user defined by code algorithms defined as user supplied algorithm or algorithm software herein. Firstly, when a user deploys algorithm software, using the user interface block 202, the user may define but is not limited to the following set of information with regards to an algorithm software deployment: algorithm reference name indicating a name of the algorithm software; application programming interface URL name of the algorithm software; the programming language in which the algorithm software is written; the data type that the algorithm ingests as a function (e.g., images, audio, text, documents, IOT sensor data, strings, sets of strings, integers, decimal numbers, list of strings, TCP data, UDP data, video data, or compressed data); a license associated with an algorithm; whether or not algorithm hardware acceleration is required; whether or not the algorithm should be deployed in specific geographic regions; the security settings for the application programming interface; the machine learning framework and version; the application programming interface type (e.g., Kafka, restful, TCP, UDP, etc.); any software dependencies or links to software dependencies algorithms may need; added documentation to aid in organization in the algorithmic development platform 200; and whether or not the algorithm will be run on both a device or hosted in the cloud. Algorithm Deployment Platform 200 defined partially in FIG. 1 has a more detailed overview (in FIG. 2 and FIG. 3) of the method that applies algorithms as cloud server-based APIs and creates device APIs to perform inference on the device when required. There are a number of ways of scaling algorithms for consumption via an API from one to billions of devices and request a number of ways of creating API's.

FIG. 2 describes method 200 that contains elements required to accomplish the method 100 (described in FIG. 1) to perform an algorithm inference based on Device APIs and Cloud APIs to provide inference either on the device or in the cloud, depending on hardware requirements. Starting with 202, a user interface is specified to let the user do one or many of the following functions: upload algorithm code, algorithm models, interface algorithm functions to APIs, manage monitoring statistics, compare algorithm models, select generated minimum viable products generated for the algorithm data type, select the deployment platform type, manage algorithm API security, manage or download generated APIs for particular device types, download or manage data collected from algorithms, restrict IP address to API's, select API type, select a cloud provider for algorithm hosting, and select a hosting platform type for the algorithm. The following functions are also included: read algorithm attributes such as memory, processor, or algorithm hardware acceleration attributes; edit algorithm configuration files; pay bills; monitor algorithm usage statistics; test uploaded algorithm code; test algorithm environments/containers; specify algorithm dependencies; and serve as an interface to one of the methods described herein. Method 204 describes a method in which the user may provide the credentials for an external cloud or server provider, and the platform may store the credentials so that the platform may be controlled through API or other means. Method 200 with 204's credentials can host algorithms internally or provide the software or function to host in other platforms. Examples of credentials may be passwords, usernames, tokens, API identities, or certificates. They may be used to let method 200, one or many different cloud platforms or servers to host algorithms. Step 206 represents API management version and naming associated with deploying algorithm APIs, and allows for IP addresses and name changes by the user; it allows the user to upload subsequent algorithm code sets and algorithm models with the same API access and credentials. Also, configurable is API traffic associated with the algorithm inference so that API traffic can be directed to different models or versions of user uploaded algorithms.

Method 206 may also search the code or model based on name and function type to find a prediction method or an inference method based on the user supplied data type for the inference. This method may be displayed to the user as feedback in determining if that particular portion of code is the correct place to interface to the algorithm for the API to access. Further, the code may be analyzed by the system to look for any models that may be loaded to help the algorithm container specify any models required to be loaded into memory by the system on the start of the server container runtime. Method 208 represents algorithm training which in algorithms, such as supervised learning machine ones, will learn model weights from data. Contained within platform 200, method 208 may have an aspect where the user can use an algorithm framework to specify data sets or data collection obtained through inference associated with the API algorithm deployment. Algorithm training data may be labeled through a manual or automated algorithmic process so that the data set may be staged for algorithm training. Annotation tools or other algorithms may be used in the algorithm training. Using user interface 202, the user may specify a user created algorithm or user created algorithm model that is then searched for functions, and dependency type and software dependency version is determined. With dependency type and version determined, software dependencies may be downloaded into a software set of dependencies and software so that error free software can be compiled and run.

Errors may be reported through the user interface 202 for input location of dependencies, code changes, or missing files for a complete set of software. Further, the algorithm or algorithm model may be searched for a predicting routine or data type so that code can be interfaced to an API software set to expose a user supplied algorithm in a specified format as defined in 212. Method 212 contains an analysis performed on the algorithm and algorithm model by performing an inference on a selectable data type to test the algorithm inference speed and computation along with the measure of model size (e.g., the number of model weights and network size of a deep learning algorithm along with deep learning architecture description) to determine the amount of time computation takes with a CPU, the amount of time computation takes with a CPU in conjunction with an algorithm hardware acceleration device (e.g., neural processing unit, graphic processing unit), and the amount of time required for a user supplied algorithm function call to execute. The amount of in memory and fixed memory may be assessed so that a platform may be chosen to test the algorithm for deployment on the different platforms (125,120, and 130). Method 214 defines a dependency determination of the software library dependencies associated with the uploaded user supplied algorithm or model in the method, parsing through function or method names, number of inputs, and any library import statement contained within the user supplied algorithm code or model. Further, with imports defined, a proper version of the correct library may be identified with either a library or version programmed; or the user may be asked what version of the software should be imported after identifying a particular library based on the import statement text within the code. Determined by the function names, inputs/outputs of functions or other distinguishing characteristics that may define software release version for software dependencies such as release notes may be used for the determination of software dependency version.

Further, software dependencies may be identified by function or method number of inputs and outputs and the type of input or output. Working with step 210, a cycle of testing and displaying errors to the user or an interpreter of the errors to try to solve the problem occurring, may also be performed so that testing and determining software dependencies may be used in conjunction with one another. Block 216 defines certificates associated with the API or a Blockchain validation approach to the API provides security for the API connections to either the device API or the cloud API. Blockchain could allow a group of users and verify identity, and then a user could generate a token for the API. Further, tokens may be set by the user or generated with a hash (e.g., sh256, MD5) to serve as a token-based login for the algorithm API. Certificates that provide encryption over a restful web service or stream (e.g., Kafka) may provide a private and public key for message encryption while transmission of data occurs between the device(s) and cloud APIs. Block 218 dictates the selection of security type such as Blockchain token based security validation, HTTPS with public and private keys for network security, basic authorization with user logins, OAUTH, AES, hashed token based security logins between the device and cloud API, or any combination of the securities listed together. API security is important if data is transmitted for inference across a network, such as a public internet, to create secure transmission of data between the device and the cloud APIs. Block 220 defines a step in which the user supplied algorithm, a generated by method 200 API, determined software dependencies, and an interface between the user supplied algorithm or model is created and is then packaged into a software container that defines a standalone run-time for the algorithm as a software application. This software container can be versioned, tested by passing an input API data type defined by the user or determined by the system through code analysis and stored for deployment in a variety of platforms for the user defined requirements for algorithm deployment. As a part of creating containers, multiple container types may be created suited for different hardware or software platforms like the ones described in 120, 125, and 130, or devices described in 105. Containers provide a standard way to package configurations, application code, and dependencies into a single software object.

Containers share the operating system installed on the server and run as resource-isolated processes, and they may be packaged in servers or in devices. As a part of the containerized algorithm and API, a user may include a model that is a part of the algorithm, and method 222 may convert the model based on a certain machine learning model framework. Conversions of a model may be related to model in weights (e.g., deep learning algorithms may be defined by a model architecture and weights that may be defined in different numerical resolutions) that may be converted from a model framework or a numerical weight resolution perspective (e.g., Fixed point 16 bit integer, 32 bit floating point, 64 bit floating point), conversion of the model format for a specified algorithm acceleration hardware format, and multiple containers or one container with multiple models may be generated as described in 222. Another component is 224 that may handle auto scaling and API traffic monitoring. Contained in the servers or containers of the Cloud API, system 200 tracks the number of API calls and the number of servers to handle the call requests. This method operates based on the computation required to perform the algorithm inference task and the latency required to do the task. The number of simultaneous containers running in parallel may depend on a measurement of API traffic, and the system may increase or decrease the number of containers. The system may learn traffic with a Neural Network, Convolutional Neural Network or regression approach; and prior to experiencing an increase traffic amount, may increase the number of servers or containers in anticipation of a heavier load. API traffic may also be monitored to count the number of requests of a user supplied algorithm for the purposes of billing. Further, the number of containers may also be counted for the purposes of billing. Method 224 for may also route traffic to devices or specify the next inference to be done differently on a client device, on a different client device, or on a different API based server device based on hardware constraints or resources available.

Using 202, a user may change the entire algorithm within a container, update an algorithm model within a container, or the algorithm may continuously learn within each distributed container through a reinforcement deep learning approach to update model weights. Method 226 describes the containers generated in 220 that may be manipulated to run on different devices or processors or be automatically deployed with an API endpoint in a distributed system or cloud servers. Method 228 describes the generation of an API automatically from either a data type defined by a user for use with the algorithm or by the platform determining the algorithm data type though analysis of the code supplied for the algorithm to see function inputs and outputs, or through function key word recognitions in the function titles. In certain algorithm instances a model is loaded into memory before algorithm inference is performed; method 228 may identify where in the code a model supplied is loaded into memory, and that portion of the user supplied algorithm code is executed upon launch of any software container. The API generated interfaces the user supplied algorithm to a URL endpoint accessible potential with security associated. Likewise, 230 defines an API generation for a device, and this may change an interface for the algorithm and a model to be a specific language type or a language snippet of code that can be imported from another software set.

The API generated may then decide, based on measuring computation and memory availability, if the algorithm can be run on a device or if the Cloud API should be called for the inference. The device generated may also not contain the model, and the model may be downloaded from a model server once it is determined that the device that the API is placed on can perform inference based on algorithm hardware or software requirements. The API generated may be generated based on data type, algorithm framework, and algorithm interface to algorithm acceleration hardware. The algorithm model and algorithm code may also change and be housed in a way that a device can perform the algorithm operation within a device accessible by an API that may not be a URL based API. A Cloud API and a Device API have differences. A Cloud API may be accessible through a Kafka streaming interface or a REST API through a URL endpoint and perform the algorithm inference in a scalable platform with many nodes running ready to perform inference, whereas a Device API may be accessible via a Python code import that would choose to perform the inference on the device or push to the Cloud API over the internet with security. The algorithm may also be transformed into a different programming language for the device API, and the algorithm model weights may be converted into a format the device may understand for algorithm hardware acceleration.

Method 232 defines automatic generation of applications; this portion of method 200 may use the Device API or container generated in the platform defined by 200. With a cloud application API created to provide access to inference of a user supplied algorithm, one such feature of the platform is to provide uses so that the user may download code or an application for a particular hardware set to demonstrate usage of the algorithm in a product or be given reference code. Examples of this may be a web application or site so that the user can drag and drop files into the site to be processed by the algorithm; a smartphone application that can take a picture, and the picture is processed by the user supplied algorithm with the cloud and device APIs and display the output to the user; an example file data selection (e.g., image, file, text, audio, video) in a smartphone application that then processes the selection with the user supplied algorithm with the device and cloud API; and a device IOT application to record sensors on a defined hardware platform and use the Device and cloud API to perform an inference with the user supplied algorithm. The examples are generated by the system taking the user supplied algorithm, embedding the user supplied algorithm in an API with a determined input and output data type. The API defining a way to perform an inference with a user supplied algorithm gives the ability for pre-created client code to be used for the many examples of usage and thus an automatic creation of the defined examples.

Other examples may be code snippets or imports for the algorithm API in different languages for Cloud or device API integrations in different embedded, smartphone, or IOT devices; augmented reality devices that display holographic images to users; or wearable glasses that augment a user's vision that uses the Cloud or Device APIs. Further examples include a demonstration smartphone app that may record audio, process the audio with the device or cloud APIs with the user supplied algorithm, and display the output of the algorithm; a demonstration smartphone app that may record video, process the video with the device or cloud APIs with the user supplied algorithm and display the output of the algorithm; a demonstration smartphone app that may sensor data, process the sensor data with the device or cloud APIs with the user supplied algorithm, and display the output of the algorithm; and a demonstration smartphone app that may record an image or process the image with the device or cloud APIs with the user supplied algorithm, and display the output of the user supplied algorithm. The displayed output may be on a different device such as IOT, embedded device, or computer. An aspect of this sub method is to automatically generate a way of demonstrating the use of an algorithm API for the user.

The method of creating is defined by determining the input and output data types to the user supplied algorithm, the software dependencies, and the algorithm acceleration hardware needed in the client device or in the cloud server. With these aspects, a user supplied algorithm may be deployed through an automated method as an API with an endpoint and security associated by 200, and used by client devices or interfaces.

As a part of method 200, sub method 234 may define a logging function that may log information about algorithm inference speeds based on platform, accuracies of prediction associated with algorithm models, number of API calls of algorithm based on time, accuracies based on algorithm version, accuracies based on version based on a percentage of the API call population, or parameters defined by the user through a tool that inspects or saves certain variables for the algorithm inference that may be stored. Further, a user may change algorithm or model versions to specific amounts of user traffic on both the Device API and the Cloud API to measure accuracy or variables defined by the user to be measured for understanding of new or differences in algorithm performances. The user may also use the customer user interface to select a different algorithm based on reports provided through the interface on measured statistics associated with the algorithm (e.g., latency measurements, accuracy measurements, or variables selected within the algorithm by user for reporting). The user may also turn on or off, rename the algorithm API, rename URL endpoints to the algorithm, adjust security associated with the algorithm, or adjust the platform type the user supplied algorithm is running within. Method 236 defines a billing function that may supply the user with a bill based on algorithm API calls recorded, the algorithm platform type, the computation requirements of an algorithm, and execution time of the algorithm. The function also supplies the need for algorithm acceleration hardware, the need for auto scaling of an algorithm, the need for a specified number of servers, the number of algorithm inferences occurring in the Device API, the number of algorithm inferences occurring in the cloud API, or the number of algorithm containers running in a specified time. It may also provide a time-based calculation for access to the platform. As defined earlier, methods 120,125, 135, and 140 are different platforms to deploy the algorithm from a cloud-based environment as a Cloud API.

Method 200 contains a storage component in 242 that defines a database for storing metadata about the algorithm or user (e.g., API name, algorithm name, URL endpoint, programming language type, algorithm dependencies, algorithm framework type, documentation about the algorithm, algorithm data type inputs, algorithm data type outputs, platform type for deployment, device type for deployment, algorithm model size, container size, API consumption reference code, tokens for API, security type for API, or API type). Component 244 defines storing algorithm models that may be uploaded to platform 200 by the user and may contain multiple versions of models for a single algorithm. Component 246 indicates storage of the algorithm code; like algorithm model storage, it may contain multiple algorithm versions for a particular algorithm model. Component 248 contains the storage of the algorithm environments; it may include the dependencies from software or a model perspective for the algorithm to compile. Contained within, may be predefined dependency sets or specific algorithm frameworks that may be loaded. Component 250 may contain storage of containers that package user-supplied algorithm code, an algorithm model along with algorithm dependencies defined by algorithm environment storage, or a containerized application that may be loaded by one of the deployment platforms. Different types of containers may be stored, depending on where the algorithm API may be deployed (e.g., in a particular cloud platform or in a device platform).

An embodiment of method 200 is shown in FIG. 3 that details a potential process 300 for the methods to create and deploy a user supplied algorithm into a scalable system, automatically or with feedback from the user to deploy a user supplied algorithm in a scalable deployment platform as a Cloud and/or Device API. Method 300 starts with a user interacting with a user interface as indicated by 202. The user may interact to train the algorithm, as indicated by method 202 interacting with method 208, wherein the user could train and develop algorithm that may be used for different use cases. Further, the user may interact with the API management tool described by 206 to version APIs and name APIs that may store the information in 246 or 246 to access the information in the future. The user interface 202 may also interact with a cloud credential provider and configuration so that user supplied algorithms and the entire platform 200 may be set up in the cloud, or certain aspects of the platform may be set up in the cloud using a user's login credentials. Alternatively, platform 200 may be hosted in an environment that does not require a user to have a cloud credential set rendering 204 unneeded and the interaction with 202 progressing to 210. System 210 is defined by a user uploading a code to define an algorithm, a construction set to define an algorithm, or a model to define an algorithm. The user may interact with 202, and a code and or a model may define an algorithm as a user supplied algorithm. System 210 may take the user defined code and/or a model, perform a dependency determination 214 and software packaging of the software dependencies in a container 220. Depending on a security approach defined by 216, a security approach for the APIs defined by the container 220 may be generated by 210. Latency and computation analysis of an algorithm may also be performed in step 212 to assess algorithm and dependency performance within a containerized application and to determine tradeoffs between different deployment platforms and the need for algorithm hardware acceleration. Further, an assessment may be performed of how much computation and space is needed on a platform for deployment in regard to containerizing the application.

System 218 defines a generation of API security based on security selection for deploying an API application; an API is generated in 210 for testing a user supplied algorithm to report problems and allow the user with a user interface 202 to change problems with an integration of a software environment, API container, or an aspect of deploying code. With the user defined code, user supplied algorithm model, dependencies by the system, and APIs defined by the system, a container (e.g., software container) is ready to be released as a packaged application in one or many systems for deploying the user supplied algorithm for consumption by many devices or other software applications. Another aspect of 220 or 210 is an interaction with a method that may convert the algorithm models; either trained in step 208 or supplied by the user through interface 202, 222 may take the models and convert them to different numeric resolutions or different formats that may be used by devices to perform inference on a smartphone or embedded device. This allows an automated deployment an assortment of algorithm models for all sorts of devices and algorithm platforms to perform algorithm inference on a device. With converted algorithm models, 220 may store the user supplied algorithm models or algorithms converted to different platforms, containers packaged for different deployments on different platforms, and dependency sets, and store them from a version and a future use perspective in order to load them into different platforms for algorithm deployment. A user may interact with method 240 that may handle algorithm updates, or model updates would be propagated to the algorithm containers. The containers and dependencies, along with models and method 226, may create different sets of algorithm containers to be released on different platforms and may store these containers for loading into an inference Cloud API platform. As a part of 226, an automatic approach to generating the API (as indicated by 228) may be used to generate Device and Cloud APIs to package into containers for inference deployment. Based on data type of the user, defined algorithm code may be generated for Devices to consume the Cloud API provided by cloud server(s) or a containerized version of code with the ability to pull models over a network (indicated by 115).

System 230 may provide a containerized application with the user supplied algorithm that consumes the Cloud API and a deployment of the Algorithm in the cloud. 230 may also contain a containerized application with a user supplied algorithm without a model that consumes a cloud API that may then pull a model from a database if it is determined that the device has the computational ability to perform the algorithm inference. System 230 may contain just an API to consume the cloud API and provide the algorithm function defined by the user fully from the cloud. Indicated by 115, the client devices may interact with these different versions of 230, and the user may use interface 202 to obtain these different versions of Device APIs as code or as applications specific to the devices in which the user has an interest in deploying the algorithm. Another component that is accessible by the user interface 202, potentially over a network, is automatic application generation to download or access automatically generated applications for demonstration of the Algorithm defined in the API based on data type. Client devices or the user may also pull the automatically generated applications for use on the Device (defined by 105, 110, or 115) that may perform the algorithm function example in the automatically generated data type. A technology example is as follows: the user may download an application from the app store that was generated by 232 or contained within 232; an example application may be generated wherein the user may demonstrate the result of the output of the algorithm function. Algorithm container storage 250 contains the packaged algorithms that may run on different types of algorithms specific to different types of devices; or server Cloud APIs may be used for different platforms (as indicated by 120, 125, and 130) that define a serverless, a container orchestration, and a container orchestration with dedicated algorithm acceleration hardware.

The system may compare these different platforms for the user to decide requirements on the system such as latency based on deploying the algorithm in one of the different platforms. Further, databases 242, 244, 246, and 248 may aid in telling method 300 which platform (120, 125, or 130) to enable, based on a user selection, or automatic determination of the system, based on latency requirements, (e.g., the time to execute the user supplied algorithm on a particular set of hardware) such as choosing a platform to process the sensor information and providing algorithm outputs with an algorithm latency time of less than one second. In the event the container stored in 250 is a large model that cannot constrain to a serverless environment, as indicated by 120, potentially only 125 and 130 may be used for deployment. With the algorithms deployed, devices 105, 110, and 115 may access the platform through the Cloud API via the Device API that may also perform the algorithm inference. Also, with updated model versions provided by the user or the algorithm training steps contained in the databases described, the different platforms may provide new algorithm or models to the Device APIs for new model inference on the device if the device has the required hardware constraints to perform the inference on the device. Between the different platforms (120, 125, and 130) and Client Devices (105, 110, 115), a network (not pictured) may exist, such as the internet or a service provider. (120, 125, and 130) may also log information about the algorithm (indicated by 234) and may also monitor API traffic (indicated by 224) to run the algorithm container on more servers or algorithm containers within the current server set, depending on historic type where API traffic increases or a sudden increases. With insights into the user supplied algorithms logged 234, the user may interact with 234 to understand information about the algorithm performance or usage along with the size of the platform required to scale the algorithm for the usage. The user may also understand the amount of inference associated to the algorithm occurring on the device and in the cloud APIs; and as indicated by 235, the user may be charged based on the number of servers or the API traffic associated with the Algorithm.

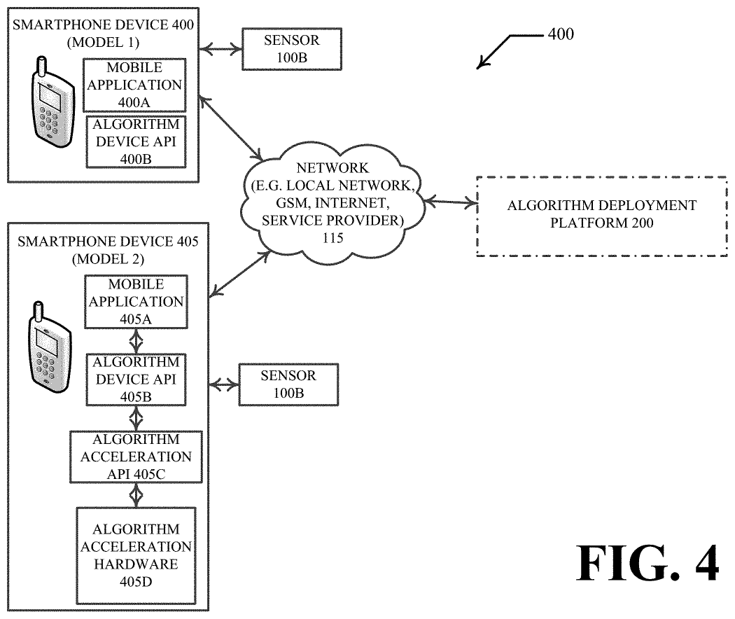

FIG. 4 is an embodiment of the interaction between the Cloud and Device API to determine when to perform inference on the device and when to perform inference in the cloud. FIG. 4 illustrates method 400 that shows the interaction between devices, as indicated by 400 and 405, that interact over a network with algorithm development platform 200 that contains at least one Cloud API. To perform a user supplied algorithm inference in a product such as a smartphone application, typically the smartphone device 400 may access sensor information such as audio, video, images, IMU data, or location data. Smartphone devices 400 or 405 may consume an API in the cloud that may perform the inference associated with an algorithm that operates on sensor data associated with the smartphone, as indicated by 100B.

Two introductions to the method described are a device API, as indicated by 400B, that is interacted with by a smartphone application 400A that may use the API internal to the device to feed data from a sensor into the API with the expectation that the API produces a user supplied algorithm result by interacting with platform 200 over a network; the computation required for the algorithm may not be enough to do the algorithm inference in the device 400. Smartphone application 400A may display the result after 400B produces the result after the platform 200 sends the result back. Smartphone application 400A may also directly access the Cloud API 200 in some instances for the direct result. The benefits of separating the device API from the smartphone application is that the complexity of performing the user supplied algorithm on the device or in the cloud API is greatly reduced to a smartphone code developer. A user may package an algorithm device API 400B into a smartphone app that is generated by platform 200 that seamlessly handles algorithm inference and updating algorithms without having to change mobile application code when updating algorithm models in platform 200. Shown in 405 is a secondary smartphone device, for the purposes of explanation that contains the same mobile application (as indicated by 405A), that uses an Algorithm device API (as indicated by 405B) and interacts with sensors 100B. Device 405 contains additional algorithm Acceleration Hardware (indicated by 405D) and an API to access the acceleration hardware (indicated by 405C). System 200 generates the algorithm device API (indicated by 400B and 405B) and may be the same API for a family of devices; however, the Device APIs may sense the device type or version and if the device has the computing ability to perform the user supplied algorithm function. If the device has the ability (as indicated in Device 405 but not in 400), the Device or Device API may download an algorithm model onto the device from the cloud API contained in platform 200, either in the same algorithm model form as the algorithm form in the Cloud API or specific to device, device version, device model, or the device Algorithm Acceleration hardware model.

Updates in platform 200 may also propagate to the device with the Device API. Due to the specialized nature of algorithm acceleration hardware 405D, potentially not required but shown, is an Algorithm acceleration API 405C that may require a special device format to run the Algorithm on device. The algorithm model packaged into device API 405B may be specific to the algorithm acceleration API 405C. Also, the algorithm model specific to the device hardware constraints may not have to be downloaded from platform 200 and may only be updated when new models are created. Device API 405B may have many models contained in the Device API, depending on device type and may load the model corresponding to the device hardware type, device operating system type, application version, algorithm acceleration API version, Algorithm Acceleration hardware version, or the hardware constraints on the device to perform the algorithm inference. Further, the device 405 may also look at the current computation load (memory, storage, computing ability, or current algorithm acceleration hardware that may be in use) on the device and determine above a certain threshold to do the inference of the user supplied algorithm on the device or in the cloud APIs. The device may also measure current battery life if it has a battery and reduce the battery required to perform the algorithm inference function in the cloud verses on the device. In one such aspect of the embodiment described herein, with interactions between the Device APIs and Cloud API to perform inference, a device API may also determine that a secondary device nearby has the computational ability to perform an inference and may rely on that device for the inference.

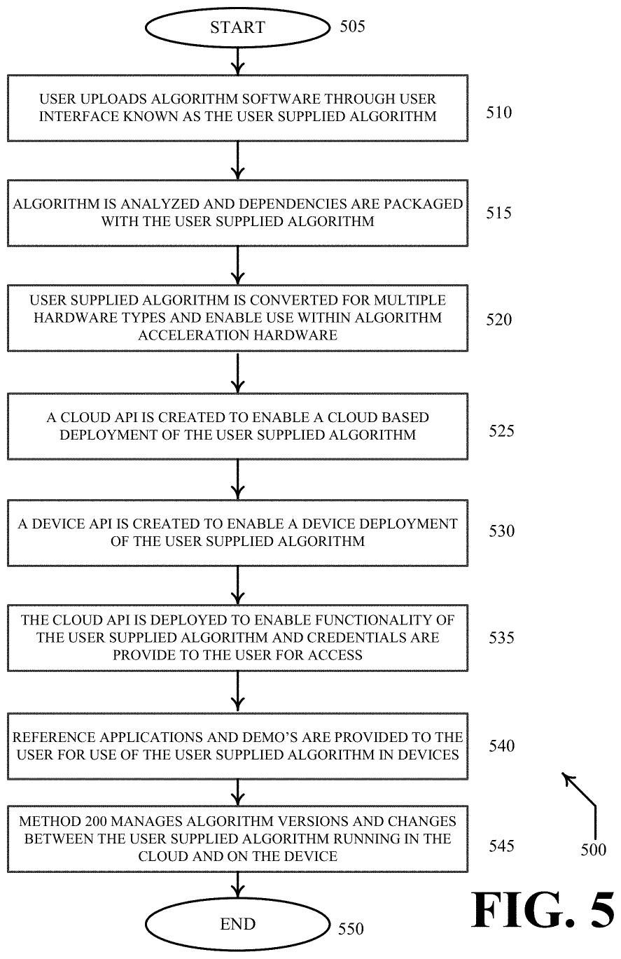

FIG. 5 describes method 500 that starts at 505 that progresses to 510 in which the user uploads a software algorithm to be deployed in the algorithm deployment platform 200. The algorithm deployment platform 200 may operate on all, some, or none of these steps listed in method 500. One reason 200 may operate to facilitate method 500 is to provide ease-of-use to enable deployment of algorithms by the user in order to enable many devices to use the algorithm. Block 505 may include algorithm model, deep learning model, code, or instruction set in the upload process. As a part of uploading the algorithm software, the user may include the algorithm input data type (e.g., image, text, audio, documents, video, etc.), other information about the algorithm such as the need for algorithm acceleration hardware, security types on API (e.g., HTTPS, basic authorization, blockchain, token-based security, and SSL certificates), or the need for the algorithm to run in both the devices and in the cloud with an automatic to termination of where the algorithm inference is done.

Transitioning to step 515, the algorithm code supplied by the user is then analyzed for software dependencies, and the dependencies are downloaded and packaged with the algorithm supplied by the user. Further, in step 515, feedback is given to the user about potential problems; and the user may be shown specific portions of algorithm code and may be required to edit algorithm code to interface to an API. In step 520, the algorithm model and/or algorithm software is then converted in a variety of ways for the algorithm to be used in both deployment in the cloud and the deployment in the device accessible by APIs. One such specificity is a conversion of algorithm models that often corresponds to model weights of algorithm architecture for deep learning or machine learning. Algorithm software may be converted to different data types or numerical resolution (e.g., float 16 bit, float 32 bit, integer 32 bit, and integer 16 bit).

Different algorithm acceleration hardware, either in devices or in the cloud, may use an algorithm hardware acceleration API interface. The algorithm and model may be converted to a specific format to interface with that API within a secondary Device API or Cloud API, or it may be embedded within the algorithm acceleration hardware API. Different types of software dependencies may also be used, depending on the hardware type that the algorithm runs into to enable the algorithm to compile. Errors may also be displayed to the user so that further information on software dependencies or code may be provided by the user, written so that code can run properly as a software application in its converted format. As a part of step 520, system 200 may automatically interface an API software set to the algorithm to enable the algorithm function to be accessed by an API. The API may also be a code set that requires some interface by the user, and the user may be prompted to write code to provide the interface point to the algorithm. With information on the data type the algorithm performs a function upon, an API may be generated for that data type and other data types. The interface algorithm code and the API may also be tested with a data type automatically so that it can be determined that the API is functioning properly. It may be asked to edit an interface point between the algorithm function code supplied by the user and generated by system 200 API code.

Step 525 details further the source code generated by method 200 to create an API that is interfaced to the algorithm supplied by the user using the cloud (e.g., 120, 125, and 130). The cloud API code generated may be in the same programming language as the algorithm or in a different language. An interface point between the code or model supplied by the algorithm and the API may be presented to the user for editing. Specific imports of dependencies may be generated by method 200, and imports into the API code set to interface with the algorithm code set may be generated by the system. The primary objective of step 525 is to connect the algorithm supplied by the user and an API that was created based on a data type; the connection is either by the system, partially by the system, or by the user. Step 525 may also have integrations with an algorithm hardware acceleration device meant to improve the speed at which the algorithm can be performed.

Step 530 operates similarly to 525 in that an API is created for a user created algorithm but with the distinction the API software generated. It is meant to run inside a device software (e.g., smartphone, IOT, or embedded device) which creates a different set of software that may have difference algorithm models, dependencies, or algorithm code, and is not necessarily exposed to a broader network. It may operate only interface to algorithm acceleration hardware or a secondary API that interfaces to algorithm acceleration hardware.

Another property of 530 is that it may contain decision of whether to perform the inference for the algorithm within the device API versus connecting to the cloud API for performing the inference. Step 535 takes a created API and user created algorithm that is integrated together for access via the API and then generates software and code for the user to integrate into an application to use the user supplied algorithm. Further, the security protocol between the client and server may be defined and presented to the user, along with the device API and/or the cloud API for the user to deploy. The cloud API may contain the ability to update the user algorithm or models in the device API when the device API is connected to the cloud API. Further, the client API may decide if inference should be performed in the device or in the cloud API. Parameters for determining where inference occurs may be a phone or device model, measured computation constraints of the phone or device model, or memory constraints of the phone or device model.

The client or device API may not include the user algorithm model or user algorithm until device constraints are identified, and the algorithm and algorithm model may be obtained from the cloud API if it is determined that the device has requirements to perform the algorithm computation function local to the device. In step 540, given a user defined data type and user algorithms, minimum viable products (MVP) may be generated to use the Device API in conjunction with the Cloud API. Examples of MVPs may be the following: a web application or a site in which the user can drag and drop files into the site to be processed by the algorithm; a smartphone application that can take a picture in which the picture is processed by the user supplied algorithm and displayed to the user; an example file data selection (e.g., image, file, text, audio, video) in a smartphone application that then processes the selection with the user supplied algorithm with the device and cloud API; and a device IOT application to record sensors on a defined hardware platform and use the Device and cloud API to perform an inference with the user supplied algorithm. Block 545 describes management, once a device API and a cloud API are deployed. Updates to algorithms and naming conventions and addresses of APIs may be structured so that updates to algorithms or algorithm models can be made and updated in the device API from the Cloud API. With the steps described herein, method 500 may end at step 550 but may be revisited to update algorithms or deploy algorithms by the user.

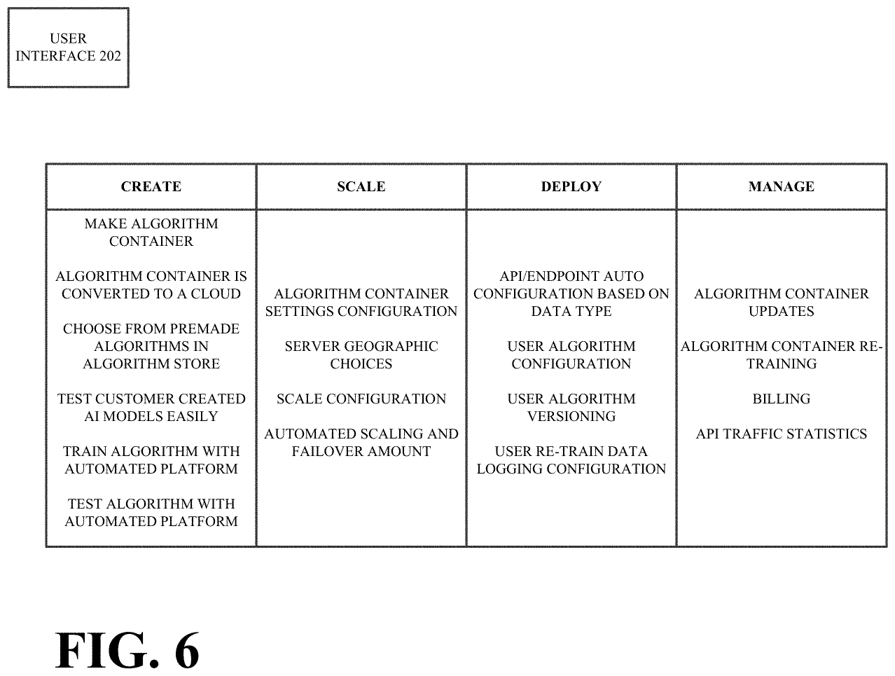

FIG. 6 defines aspects of user interface 202 to demonstrate functionality that could occur in an interface such as a website, mobile application, or software-based user interface for creating, scaling, managing, and deploying user supplied algorithms. The user may use the portal to define data types for user supplied algorithms, create containers and APIs that the user may utilize for deploying algorithms, test and train algorithms such as machine learning or deep learning algorithms, select algorithms pre-made for particular data types in a repository, or test and edit models in the creation step through a user interface. Further, a user may select different platform types, geographic choices, scaling configuration for servers, and types of server scaling. With Algorithms deployed, a user may configure endpoints, version algorithms, re-train or add updated models or architectures to algorithms deployed, or log particular aspects of the code based user supplied algorithms. The user may also manage billing; re-deploy the APIs containing algorithm defined by the user; or monitor statistics such as algorithm accuracies, usage, or errors of the algorithm with a managing component of the user interface.

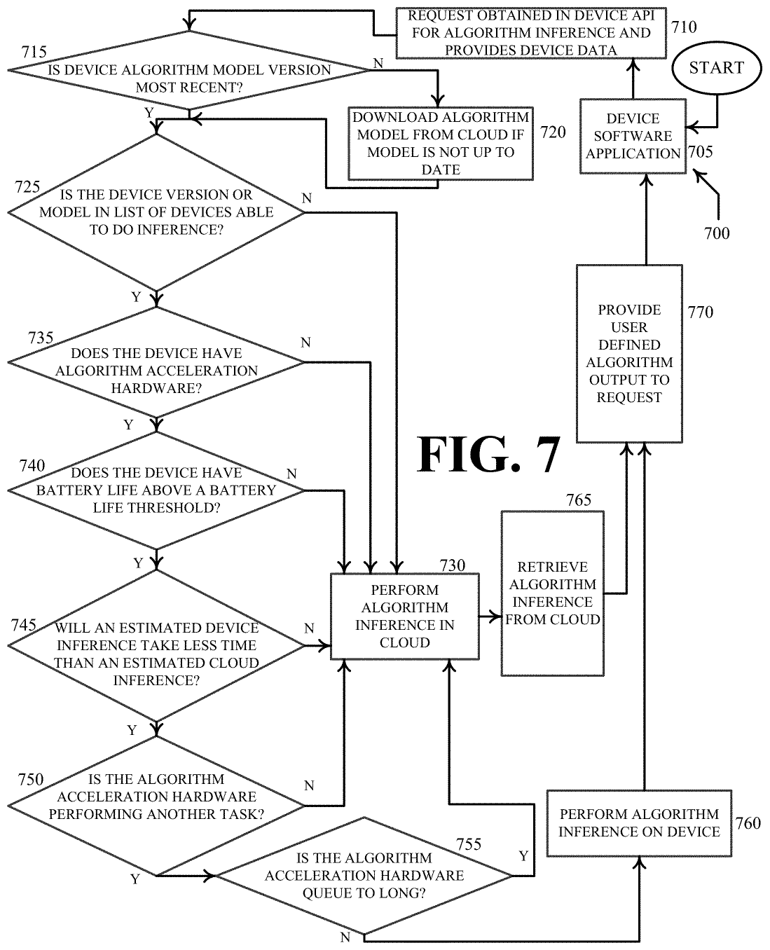

FIG. 7 describes method 700, which is an approach in determining how to perform a deployed user supplied algorithm operation on a device versus in a cloud, and in determining decisions to perform inference in devices and when to pass data for an algorithm function to perform inference in the cloud. Starting at 705, a device software application may be used to record, process, and have a user interface for a product or feature in an IOT, server, or cellular phone device. Typically, the device may record images, audio, video, or sensor data and display a result from an algorithm defined by a user that created an algorithm and deployed it in the algorithm system 200. The output of the algorithm may be sent back to the device, stored, or displayed on a different device, depending on the application of the user supplied algorithm. Encompassed in 700 is a method that shows a decision to perform the inference in the device versus in the cloud. When a device requests that an inference be performed, triggered by a device user or sensor measurement, 710 requests that the device perform inference from the algorithm. In the cases of large networks of devices such as smartphones, different smartphones contain different computation abilities and may have dedicated hardware for machine learning, deep learning, or algorithm acceleration. For a user supplied algorithm to be deployed across both devices that can perform the algorithm and devices that cannot, a method is in place to make the decisions for the algorithm inference to be performed on the device or in the cloud. Upon a request, 710 (shown in step 715), check if the device has a model to perform inference and if the model is most recent; often in a device's specific converted form, the device may request the user supplied algorithm from the cloud.

The model is determined by checking with the Cloud API that the model is not up to date. The device may re-download the model and update the model within the device for device inference, as indicated by 720. If the algorithm is the most recent, then 700 transitions to 725. Step 725 defines a check that compares a device version; and if the device version is in a predetermined list of devices computationally able to perform the user supplied algorithm inference, then the device may potentially perform inference on the device as indicated by the pass to 735. If not, the device requests inference to be performed in the cloud (as indicated by 730) that requests a cloud server with algorithms running to perform inference. This cloud inference is often done by using a network and performing a request over the network via a web service and retrieving a response that may be the algorithm output. This is indicated by the transition from 730 to 765 to 770. Further, platforms described in method 200 (as in 120, 125, and 130) may be used to perform the algorithm inference, as indicated by the interaction between (105, 110, and 115) and (120, 125, and 130). Step 735 describes a check that may be performed to see if the device has hardware for algorithm acceleration. The device may also perform an analysis on if it has the computational ability to perform the required inference. Further, the device may be using the hardware for other algorithms or functions, so the hardware may not be available for the inference function; at this point, method 735 transitions to 730 wherein the user supplied algorithm inference is performed in the cloud. If the device is able to perform inference based on having algorithm acceleration hardware, method 700 may transition to 740 to determine (from a battery perspective) if it would be less power consumption to perform a user supplied algorithm inference in the cloud or in the device, typically by a threshold value for the device's battery level. A calculation of power (required in the device versus power required to send to the cloud) may be performed or predefined so that a determination can be made based on a threshold of device battery life if the inference is able to be performed in the device.

Often battery operated devices may have a low power mode in which the device may be below a certain percentage, and that may be the threshold wherein the device performs inference in the cloud versus the device based on the power constraints of performing the inference on the device. Another check (indicated by 745) to decide to perform inference (on the device versus in the cloud) may be a calculated time for the inference to be performed on the device hardware versus in the cloud hardware. This calculation may be based on other operations being performed in the cloud or other operations being performed in the device that may be other software applications or processes occurring on the device or in the cloud, resulting in a queue for the user supplied algorithm operation to be performed. As such, a cloud inference estimated time may be determined, and a device inference estimated time may be determined; the lowest may be chosen. As such, method 745 may transition to 750 that ultimately will perform inference on the device, or it may transition to 730 in which a cloud inference is performed. Step 750 defines another check to perform inference in the cloud or in the device by checking algorithm acceleration hardware to determine if it is required to perform the user supplied algorithm operation and if it is performing another task that would take a longer amount of time than performing the inference in the cloud (as indicated by the transition to 730 or 755).

Similar to step 750, step 755 describes whether there is a queue of tasks that may take too long; if so, the algorithm inference may be performed in the cloud or the device may transition to 760 in which the algorithm inference is performed on the device. The device may contain one, some, or all of the checks to perform inference on the device versus in the cloud, depending on the device and the device application. If the inference is performed on the device or in the cloud (as indicated by 760 or 765), the output of the user supplied algorithm is provided, typically back to the software application; but it may be stored in a database that is sent to another device or application (as indicated by step 770). Demonstrating the output being sent back to the device, 770 transitions back to 705 wherein other inference may be specified. In other applications, concurrent approaches to these inferences may be generated.

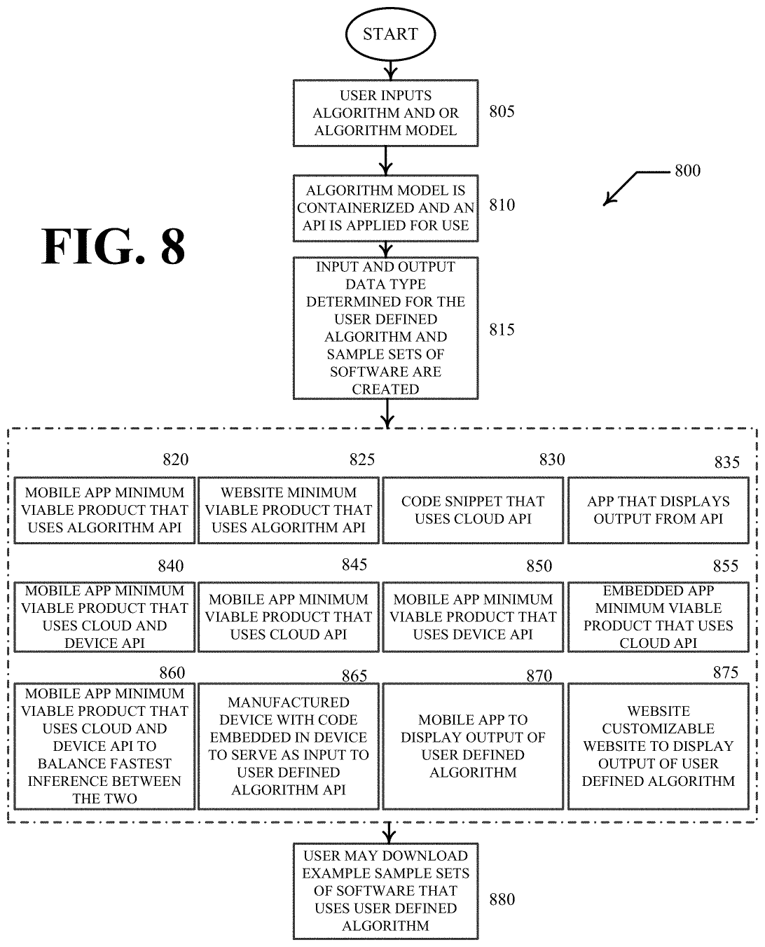

FIG. 8 describes method 800 that overviews how user defined minimum viable products are generated from a creation of a user supplied algorithm embedded in an API. As discussed herein, users may upload an algorithm or function that may be performed based on a particular data type. The data type may be determined or provided by the user as the input and/or the output of the user supplied algorithm function and used to create a demonstration application, product, or software set for the purposes of showing the algorithm function on a variety of devices or platforms. The method starts at 805 with the user providing an algorithm and/or an algorithm model for an API to be generated. The method transitions to 810 wherein the user supplied algorithm model is used to containerize and deploy in a platform like the one described herein.

With an API defined and an algorithm deployed, the inputs and outputs of the Device API, Cloud API, or inference of the algorithm is determined; and the system herein creates a variety of sample applications that can be used for testing, development, demonstration, or a finalized product to use the user supplied algorithm provided. As a non-limiting example, the user may have an algorithm that detects the number of zebras in an image and would deploy an algorithm that, given an image, displays the number of zebras. Method 800 would generate a variety of samples used by the embedded API code, based on the data type defined as an image, into multiple example products and applications. For example a mobile app may be generated wherein the user can take a picture; the user supplied algorithm processes the picture taken for the number of zebras and displays (in the app) the number of zebras for the image.

The user may obtain the discussed app, either through a smartphone application store or by downloading the application though a user interface that could be in the form of a compiled software application or a software application project in which the code is viewable and changeable by the user. Another potential example would be a website in which an image could be uploaded through the site, wherein the site would specify the output of the user supplied algorithm which is (e.g., the number of zebras). The method herein describes the approach to creating these sample applications for a variety of applications and data types. To aid in the speed of the user supplied algorithm, use development and creating products from the user supplied algorithm. Blocks 820 through 875 demonstrate examples of a product produced by the platform for the user to demonstrate their created by the platform API instead of a user supplied algorithm. System 820 is an example that may use the input data type, such as a camera, audio, picture, or location, wherein the user may interact via a user interface with these sensors to take a picture, record audio, enable phone sensor data, or take a video to provide the input data type for an algorithm to be performed. System 820 would then process the input data type provided and provide the output to the user. System 820 represents the described application as a generated mobile application that fully performs a demonstration of the sensor data with a mobile application user interface, and then the output is sent back from the API and displayed in the application.

The applications 820 through 875 may be provided either as a compiled software application or may be a code set that can be downloaded by the user. System 825 is similar in how sensors and the interfaces may be defined but within the context of being a website to demonstrate, using the algorithm that was created by the system. For example, the user may upload a photo, and the website would provide the user supplied algorithm output based on the photo. Further, this generated website may not be oriented towards photos only but may be any of the input data types provided by the user or determined though analysis of the algorithm. System 830 may be specific code sets or snippets that allow for the Cloud API to be accessed through multiple languages so that the input data type can be provided, and an output from the Cloud API can be obtained; the algorithm via the cloud can be integrated into different programming based projects, using different programming languages.

System 835 describes a smartphone, web or computer application that may only display the output of an algorithm from the cloud API so that outputs of the user supplied algorithm from a whole population of devices or a single device may be displayed. The user may use the application for monitoring or displaying the output information from the input information.

System 840 describes a sample application for a smartphone that may use both a cloud and device API that may include the method described in 700 for determining the tradeoff between performing inference on the device or in the cloud. The app (as in 820) may use a user interface to obtain the input data and provide the output on the device so that a fully working product may be generated and used by the user for demonstration of the algorithm. System 845 is similar to 820 and 840; however, instead of an algorithm API that may be just an algorithm running embedded in the software application generated, the inference of the user supplied algorithm is done in a server deployment and is performed via accessing a cloud based API over a network. This approach may be the only one or may be better for smartphones that have less computational abilities than required needed to perform a user supplied algorithm function.

System 850 performs the inference by accessing a device API that performs the user supplied algorithm function on the device instead of accessing a network, and it may access an algorithm acceleration or machine learning framework API to accelerate the algorithm function on the device. System 855 demonstrates the same types of apps (like those in the smartphone) but may be oriented to easily run as a software application to access an algorithm input data type and provide an algorithm output with a cloud API, either to a device or to a request from a different system, to the cloud API performing the inference.

System 860 serves as an example of a mobile application that may use method 700 or a similar method to balance inference between the device and the cloud; so the faster of the two platforms can perform the inference, or the best available platform could perform the inference. An example may be a smartphone application running on a defined operating system such as an Android phone or an iPhone. System 865 defines the same type of system that could balance inference on the device and cloud; but it primarily provides access to the output inference from either the cloud or device, specified by an API to provide the user supplied algorithm output. Likewise, 870 may be a mobile application that displays the output (based on a defined input or output data type of the user supplied algorithm) to only display the output of the algorithm that may be from another 820-875 system serving as an input.

For example, an embedded security camera system may provide a video feed that is defined as the data input, and 870 may display the video feed but with objects annotated in the video feed defined as the output of the user supplied algorithm. In this example, the user supplied algorithm would be defined as the object detection algorithm. All the user would have to provide to the system is the object detection algorithm. The application to record the data and to send it to an API would be automatically generated based on data type; the mobile application to display the output would be automatically generated based on input data type and the output data type. System 875 is similar to 870; however, it is different in that it is a website instead of a mobile application that may display the output of the user supplied algorithm. For example, 820 through 875 may be inputted by a community of software developers, wherein the example applications are created by a community to use a defined data input from a user supplied algorithm and to provide the resulting demonstrating output. As such, embedded applications, TOT applications, computer applications, or smartphone applications could be used to demonstrate user supplied algorithms, running with a cloud API or a Device API, to easily enable development of products for users.

Step 880 is an example of a portal, API request, or user interface website from which the user providing an algorithm for deployment may obtain sample applications 820 through 875. They are generated for the user's specific provided algorithm and/or for the user's API endpoint of the cloud or Device API, once the algorithm is deployed so that they may use one or many of the examples for products, example code, or demonstration of the algorithm deployed in an easy way.

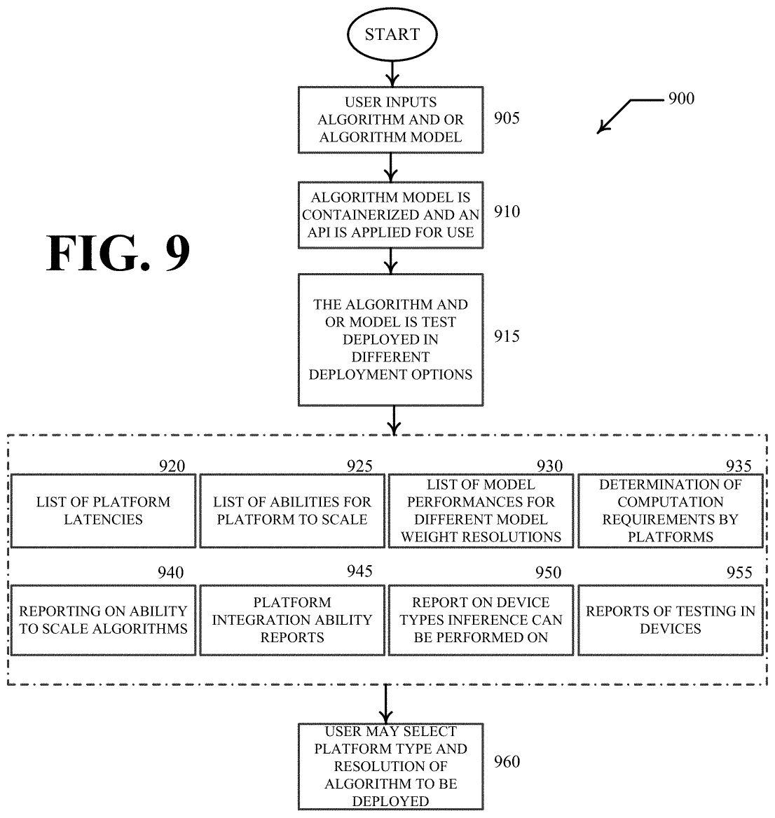

FIG. 9 demonstrates method 900 that provides feedback on user supplied algorithm statistics, type of platform best suitable for algorithm deployment, computation, algorithm performance based on different algorithm model conversions, and the ability for the algorithm to be integrated into different systems. Method 900, starting at 905, has a first step of a user providing a user supplied algorithm; then the user supplied algorithm is analyzed for software dependencies, and a containerization of the algorithm is applied for use in different platforms. An API may be created for access, and the input and output data types may be conceived in the creation of the API inputs and outputs (as indicated in step 910). Step 915 defines testing of the algorithm model and API in a variety of ways and platforms (discussed in 920 through 955). System 920 defines a test in which the user supplied algorithm is deployed on different platforms that could include (120, 125, and 130) or others where tests are performed. Tests may include testing the time it takes to perform the user algorithm defined function, defined as the latency of the inference function. Examples of different platforms may include: IOT or Embedded devices 100, client devices with algorithm acceleration hardware 100, or 2nd client device/servers. Other platforms may include event driven serverless API deployment 120, container orchestration system deployment 125, container orchestration deployment with dedicated acceleration hardware 130, or algorithm API servers 140. In the platforms mentioned, different hardware configurations may be present that would produce further test for different hardware or software requirements that may exist in the platforms (e.g., algorithms acceleration hardware differences, CPU differences, memory differences, and data type of the algorithm acceleration hardware differences). The latencies of the different platforms may be shown, or the lowest value may be used for deployment. The latency on different devices for the device API may be also tested and displayed to the user (for platform selection or as an informative value to show what platform may have been chosen).

System 925 defines scalability of the algorithm across different platforms. Certain platforms may not allow an algorithm to scale based on dependency set size, size of the container, need for Algorithm Acceleration Hardware, or other criteria. These aspects may be chosen automatically or may be displayed to the user for feedback in the section of what platform to use.

System 930 shows testing different models and model weights associated with machine learning or deep learning algorithms, typically performed on Algorithm acceleration hardware. Model weights may be increased or decreased in numerical resolution; the results of testing data sets against the algorithm for precision and recall may be performed and reported back to the user or may be automatically chosen.

System 935 defines a check to determine the computation requirements for the different platforms and may choose a particular platform based on a trillion operations per second or a trillion floating point operations per second calculation. The analysis may be performed on a deep learning algorithm or on an algorithm model, or the model may be compiled and tested for one or many function operations of the user supplied algorithm. System 940 may report or select, based on threshold values, a platform in order to scale the user supplied algorithm; or it may put forth generated documentation for the user to choose what platform the user supplied algorithm may be hosted within.

The user may be able to select what type of platform, and platforms may be eliminated based on criteria such as model size, dependency size, or computation constraints of the tested user supplied algorithm. The user supplied algorithm may also be tested for the ability to integrate with different devices via a model conversion, containerization, or ability for a generated device API to run as an application on different devices or in different compiled programming languages. A report on the device types or the offered applications (e.g., 820 through 875) may be increased or decreased based on an analysis of the ability to run a particular platform and the input and output data type of the user supplied algorithm in both the hosted cloud or on device. Likewise, for just deploying on device inference with a user supplied algorithm, a list of device types may be generated, and code may be generated, or applications generated for the included device types (as indicated by 950). System 955 shows an analysis that may be performed to run the algorithm on a set of test devices to test functionality. For example, an algorithm may be deployed and tested across different smartphone test devices or a simulated test device. This is to determine a list of devices on which a cloud API or a device API should be used for inference (on the device versus in the cloud) for system efficiency. System 955 may have devices set up to quickly deploy the user supplied algorithm in the devices as a testing system to determine functionality. Lastly, 960 may define where the user receives a generated report about the different aspects described in method 900 or may choose different configurations or reports generated in (920 through 955).

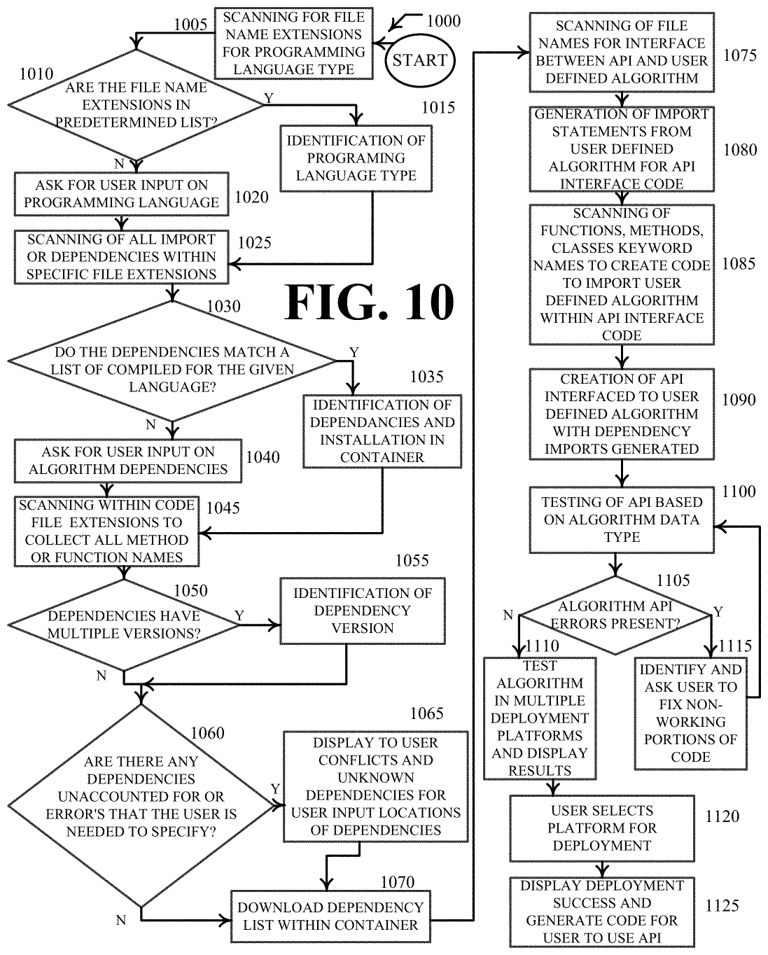

FIG. 10 describes method 1000 that defines a method to dictate the interaction between a user and a system to deploy a user supplied algorithm and/or model into an API, while handling different steps to the deployment with automation. The method 1000 starts at 1005 wherein the user may upload code and/or a model, defined herein as a user supplied algorithm to be deployed in a system on devices or in the cloud, yet it is accessible by devices. At step 1005, the user supplied algorithm may have a file system scanned so that file extension names may be sensed, and the list of file name extensions may be compared to a predetermined list to determine the programming language type in steps 1010 and 1015 that progresses to 1025. If the scanning of file extension 1010 does not contain file names that correspond to a programming language, the user may be alerted and asked for what type of programming language or framework the user defined model is created (for interfacing purposes).

All files identified as the language may be scanned within for programming dependencies, and in step 1025 and step 1030 wherein comparisons to programming import statements are compared to a predetermined list that contains links for downloads within a system being enabled by API deployment. If dependencies are available, 1035 downloads the dependencies into the environment to allow for the user supplied algorithm code to operate within with additional software required. If dependencies are found that are not identified, the user may be prompted to specify the location for download from a link, upload through a user interface, or edit the user supplied algorithm code change for the dependencies. Step 1040 asks for input from the user on algorithm dependencies if the system cannot determine the dependencies available for integration. Step 1045 defines scanning of the code within the identified files for function, class, or method names and usages of the functions, methods, or classes, along with data inputs and outputs of the classes to identify the dependency version.

With identification of the dependency version, 1055, the download or integration of the dependency may be specified with a particular version. If only one version exists, the method will use the one version available and progress to 1060. Step 1060 checks whether dependencies or errors are present in running the code or integration of the code. The user may be alerted of the problems with compiling or running the code and asked to change dependency versions, point to locations of other dependencies, edit the user supplied algorithm, or perform other fixes that may involve the user's input to compile and run the algorithm code. With checks performed and dependencies determined by the system or the user, 1070 downloads dependencies so that an error free API application with the algorithm can be made. The system progresses to 1075 where the files may be scanned for key words of functions or analysis of where data inference may occur based on seeing inputs and outputs of a potential user algorithm function. Key identifiers (e.g., image data, audio data, and file extensions) for prediction of a data input that provides an output may also be determined based on analyzing data type within. Further key identifiers for prediction names may be determined based on name (e.g., functions, classes, or methods named “predict”, “inference”, “detect”, and “perform”) that may indicate a portion of code or model that performs an inference.

Algorithms will take class or method structure of loading a model and then performing an inference with the model loaded; the model is loaded using a particular algorithm framework. The method may scan text for determining where a model is being loaded and where the model is being used for interface to a function, class, or method to perform an algorithm inference. Based on determining where an inference is occurring, import statements to the file housing the functions, methods, or classes may be generated in step 1080; and code to interface to an API that provides data inputs and outputs to the API may be generated.

The user may be asked to perform the integration to the API in code with generated code, or the generation may be done entirely by the system in step 1085 (based on name and data type determined) flowing though the user supplied algorithm. The system builds an API for the input data type and to return the output data type, along with the software dependencies, and containerizes the application for deployment on different device or cloud platforms so that the algorithm is accessible and scalable for many devices or interfaces to the API. Step 1090 pieces all the dependencies, the API created, and the interface to the user supplied algorithm code or model for a code set readable from a deployment platform.

In Step 1100, the API is tested for errors generated by passing the data type through the API interface for a defined output for errors, along with testing on different platforms for deployment. Step 1105 senses if errors are present and asks the user to fix errors, if present in testing the system, or alerts a system proprietor of errors in the API code verses errors that a user submitting an algorithm to the platform may be able to fix. If one or more errors exist, and the user changes anything in the integration, then a retest occurs until no errors exist, and the method progresses to 1110. The working user supplied algorithm is then tested in many different device deployments and/or cloud deployment platforms to report to the user aspects of choosing to deploy in the different platforms. The user may select, or the system may choose to deploy in one of the platforms based on the algorithm or a predetermined set of criteria for the algorithm.

An example of an algorithm that could be deployed may be a General Adversarial Network (GAN) that stylizes images trained from other images. Such an example may be used for a marketing initiative or contest for promotion in which the image stylization may be trained from images with brand characteristics similar to the brand. For example, a soft drink company may train an image-based stylization GAN to transform the image and may provide logos prior to or after processing the image with a GAN in the form of a mobile application running on a smartphone. Customers of the smartphone app may take pictures that are processed to look like a world colorized like the branding of the soft drink maker and may compete for best picture or picture of the day with the stylized images. The competition may result in branded GAN based images, and the winner of the competition of the day receiving rewards or soft drinks as rewards.

Disclosure of particular hardware is given for purposes of example, and the diagrams and particular steps defined herein may be performed in alternative orders. As a general matter of the steps recited herein, claims below may be performed in a different order than presented in the claims and still be with the scope of the recited claims. Function may also be referred to as a method depending on programming languages. Another approach to using an Algorithm Development Platform may be in conjunction with a Device being a satellite or spaceship with imaging sensors that looks at earth or another planet. In such a device, the image may be processed in a Device API or Cloud API wherein the image may be processed with a semantic segmentation algorithm. In such an image, the number of people or passenger vehicle may be counted for a particular time sample for given coordinates or constraints for a parking lot or location.

The number of vehicles may be identified by processing the image with a user supplied algorithm that determines the number of vehicles within the constrained location area for a specific time. The same location area may be processed for a time following; and a comparison to the number of vehicles, pedestrians, objects, or a classification within the image may be reported. The report of the change in objects, cars, people, etc. may be used to report for an insurance rating or premium of a property. It may be used to report the following: assets, the inspection of assets moving in or out of the property, the number of test driven vehicles if the parking lot is an automotive dealership, the number of vehicles or vehicle types within an auction house entering or exiting, inventory and number of colors of vehicles or vehicle types, the number of pedestrians at an event, the amount of trains in a train yard or on tracks, the directionality of trains traveling on tracks based on the comparison of the counts in time.

One such usage of an algorithm development platform may be a method to provide ingredients automatically for application user related to recipes and food ingredients embedded within a mobile application or website. A user may provide a link to a recipe and an algorithm found on the internet, or the method may provide the ingredients automatically added to the user's virtual shopping cart and present the user all the ingredients so that the user may cancel ingredients that they do not want to buy or already have for a web order shipment. The method may ask a user what ingredients they may have and keep track of them so that the user's web store car would not have the ingredients added to the cart. Further, other recipes may be suggested based on the ingredients that may require further ingredients but use similar ingredients to the user's web store cart so that the user may get multiple recipes out of the same ingredient's list. These recommendations may be provided through machine learning techniques or recommendation systems. One such aspect of the system is to ask the user if they have specific non-perishable items, such as spices, and group them in a similar section of the shopping cart after automatically adding them to the shopping car in order that the user may remove them quickly. In addition, automatically added grocery items may be grouped categorically for easy adding or removing by the user. If multiple recipe links are provided, the user's grocery items displayed may have corresponding recipes next to the item, and recipes sharing ingredients may display many recipes next to the ingredient. Thus, the system makes shopping online more user friendly and faster to purchase food-based ingredients via the world wide web.

One method that may be deployed in algorithm development platform 200 may be a method that organizes an ingredient's box based on skills to help a user gain skills in cooking recipes. The user may first select a cooking skill associated with a questionnaire based on their preference for food category, food likes, understanding of cooking, understanding of cooking techniques, or dietary restrictions. The system may send them recipes or a meal that is tailored to the person, based on the defined skill level. After the person has cooked the recipe or meal that was delivered to them by the system, the user may rate the meal and how hard it was to cook, along with the new skill they may want to try with a subsequent recommendation. The system may also display videos based on their skill level for the new techniques. As time progresses, the system may use the feedback provided by the user to change subsequent meals and recipes to improve the user's skill or to allow for new cooking techniques to be learned through cooking meals in which the user is interested. The meals provided may be sent on a specified time period, such as monthly or weekly, and the user may be charged for the service with a time-based fee.

A potential user interface is displayed for making an algorithm container in the algorithm development platform 200. The user may provide names of APIs, programming language type, input and output data types, server types, region of deployment, and programming dependencies associated with the algorithm. A user interface is possible in which the user may provide upload with a GIT version control though a link and password for providing the code in an algorithm server container, along with the ability to direct upload files associated with an algorithm so that an algorithm may be defined by code.

A step in which the code uploaded by the user is displayed though a portal online so that the code related to the algorithm can be edited to connect the algorithm to a method or function created, based on input and output data type and initialization of models stored in CPU or GPU RAM memory. In the embodiment, the user may also test their coder running on the server to see if the interface worked correctly. Further, the software dependencies provided may be scanned for name and version so that it can be determined if they are available for download and usage by the algorithm for deployment. Upon successful completion of the integration between the algorithm and the API through generated code, and testing of the integration, the user may continue to a next step. In the next step, the user may present cost associated with the algorithm and provide a change for the user to further document the algorithm deployed. The user may define a final step wherein the user may obtain code in different languages to interface to the deployed algorithm, along with downloading mobile applications that may allow the user to use the code running as an API to demonstrate the usage based on input and output data types.

What is claimed is:

1. A method, comprising:
generating a dataset of dependencies that corresponds to analyzing a set of user supplied algorithm code and comparing function names to dependency libraries determining software dependencies automatically from analyzing a user supplied algorithm code;
creating an application program interface based on naming convention and data;
creating code in an interface code document and imports based on software file names;
determining code language based on file name extensions and text attributes in the user supplied algorithm code;
interfacing code for loading a software initialization and to operate on a data for a user supplied algorithm code computer software;
calculating the computation of a user supplied algorithm;
deploying software code into one either a server with algorithm acceleration hardware set, CPU server set, or serverless environment from feedback by a user and a user registering a choice for choice.

2. The method of claim 1 wherein a deploying software code is performed by access with a user's login credentials in a cloud server user interface.

3. The method of claim 1 wherein a determination of the computation of the user supplied algorithm results in the method selecting graphics processing unit or algorithm hardware acceleration system from measured computation.

4. The method of claim 1 wherein a data type choice is selected by a user corresponding to an input and output of an application program interface and the user supplied algorithm is interfaced with the selected data type to the application program interface.

5. The method of claim 1 wherein an analysis is performed to compare systems with algorithm hardware acceleration to CPU based servers, and to serverless for a calculation of latency of the user supplied algorithm to be performed.

6. The method of claim 1 wherein an included configuration of automatic scaling of servers or software threads based on provided computation requirements of the user supplied algorithm may be performed.

7. The method of claim 1 wherein a user is informed of latency of the user supplied algorithm for different deployment platforms and the user may make a choice to deploy in a one of the deployment platforms as specified by the user.

8. The method of claim 1 wherein the user supplied algorithm is tested for inference speed and includes user defined algorithm model weight sets that are tested with different model weights with the weights being represented by different numerical precisions.

9. A method, comprising:
generating a containerized software from a user supplied algorithm with an input to the user supplied algorithm defined by a set of instructions code or algorithm model that is specified by a user through a user interface, wherein the user supplied algorithm takes data from an application programming interface defined in the setup of the selection of the containerized user supplied algorithm;
determining based on the selected data a software set to generate a sample set of software to demonstrate usage of the application programming interface and user supplied algorithm with specified data by a user.

10. The method of claim 9 wherein the specified data by a user is an image, video, audio, text, document, IOT sensors, sensor data, or LIDAR data.

11. The method of claim 9 wherein the sample set of software produced is a mobile phone application.

12. The method of claim 9 wherein the sample set of software produced is an image capture mobile phone application that displays an altered by the user supplied algorithm image output.

13. The method of claim 9 wherein the user supplied algorithm is a deep learning algorithm.

14. A system, performing:
A user inputted algorithm function defined by a set of instructions code or algorithm model encompassing of one or more client devices and one or more server devices:
comprising one or more client devices or server devices;
determining based on a criteria of a client device a calculated algorithm computation size, client computation ability, server computation ability, client device battery life, or client device algorithm acceleration hardware with ability to perform algorithm computation;
determining if to perform user supplied algorithm function on the device or to perform user supplied algorithm function one a networked in a server device.

15. The method of claim 14 wherein some client devices have algorithm acceleration hardware and some client device do not have algorithm acceleration hardware.

16. The method of claim 14 wherein the client device performs the user supplied algorithm function if a device battery life measurement is above a predetermined threshold.

17. The method of claim 14 wherein the client device performs the user supplied algorithm function if a device has the presence of algorithm acceleration hardware.

18. The method of claim 14 wherein the client device determines based on device model number to perform algorithm function on device instead of in a server.

19. The method of claim 14 wherein the client device downloads a user supplied algorithm from a server if it is determined that the device can perform the algorithm function based on criteria.

20. The method of claim 14 wherein the device interfaces to a server with a generated client application program interface and server application program interface.
